(19) United States
(12) Patent Application Publication
(10) Pub. No.: US 2016/0030915 A1
(43) Pub. Date: Feb. 4, 2016

(54) Supported Sulfides for Mercury Capture

(71) Applicant: NOVINDA CORPORATION, Denver, CO (US)

(72) Inventors: Thomas K. Gale, Highlands Ranch, CO (US); Michael A. Lucarelli, McMurray, PA (US)

(73) Assignee: Novinda Corporation, Denver, CO (US)

(21) Appl. No.: 14/774,361

(22) PCT Filed: Mar. 12, 2014
(86) PCT No.: PCT/US14/24001

§ 371 Date: Sep. 10, 2015

Related U.S. Application Data
(60) Provisional application No. 61/778,792, filed on Mar. 13, 2013.

(51) Int. Cl. B01J 20/04; B01D 53/81; B01J 20/32; B01D 53/64; B01J 20/10; B01J 20/30

(52) U.S. Cl. CPC B01J 20/045; B01J 20/10; B01J 20/3085; B01J 20/3234; B01D 53/64; B01D 53/81; B01D 2257/602; B01D 2251/404

(57) ABSTRACT

Herein are described methods and materials for capturing mercury from, for example, the gases produced by the combustion of coal. The composition for the removal of mercury from the fluid includes a polysulfide selected from the group consisting of a calcium sulfide and a bromosulfide; the polysulfide supported by or carried on a surface of a silicate particulate. Disclosed methods include a process for manufacturing the bromosulfide or calcium-sulfide mercury-removal composition and a process of capturing mercury from a fluid, the process can include admixing a bromosulfide or calcium-sulfide mercury-removal composition and a fluid that includes mercury; wherein the bromosulfide mercury removal composition includes a bromosulfide supported by or carried on a surface of a silicate particulate; wherein the calcium-sulfide mercury-removal composition includes a calcium sulfide supported by or carried on a surface of a silicate particulate.

### CROSS-REFERENCE TO RELATED APPLICATIONS

This disclosure claims the benefit of priority to U.S. Provisional Patent Application 61/778,792 filed on 13 Mar. 2013, the entire disclosure of which is incorporated herein in its entirety.

### FIELD OF THE INVENTION

This invention relates generally to pollution control and more specifically, to adsorbents which substantially reduce the amount of mercury released into the environment by coal-fired utility pants and from other sources.

### BACKGROUND

Mercury and its compounds are significant environmental pollutants and major threats to human life and natural ecosystems. Mercury is of significant environmental concern because of its toxicity, persistence in the environment, and bioaccumulation in the food chain. The toxicity of soluble Hg ions and elemental Hg even in very dilute concentrations has been widely reported in the literature. Mercury is released readily into the environment from natural and anthropogenic sources. Because of its physical and chemical properties, mercury can also be transported regionally through various environmental cycles. Atmospheric deposition of mercury is reported to be the primary cause of elevated mercury levels in fish which is a potential threat to pregnant women and young children.

In the United States, coal-fired power utility plants are the biggest source of mercury emissions into the air, emitting at least fifty metric tons of mercury into the atmosphere annually. Coal-fired combustion flue-gas streams are of particular concern because of their composition that includes trace amounts of acid gases, such as SO₂, NOₓ, and HCl, plus CO₂, oxygen, H₂O. Other sources of mercury emissions may include the chlor-alkali industry, ore smelting, gold refining, cement production, fossil fuel combustion and incineration of sewage sludge or municipal garbage or the like.

The major chemical forms of mercury in combustion flue gases, including coal-fired flue gas, are elemental Hg⁰ (i.e. zero valent) and oxidized mercury (e.g., Hg(I) and Hg(II)). Mercury speciation (elemental or oxidized) and concentration is dependent on the source (e.g. the characteristics of the fuel being burned), process conditions, and the constituents in the ensuing gas streams (e.g., Cl₂, HCl, SO₂, NO_{N}). The oxidized form of mercury (typically HgCl₂) is the major species found in waste incinerators effluent. In coal-fired power plants, much of the elemental mercury released from the coal in the furnace remains such to the stake at many power plants, due to the activation-energy barrier preventing the elemental mercury from oxidizing without sufficient catalytic assistance. The only inherent catalyst for oxidizing mercury in coal-fired power plants is the unburned carbon in the fly ash. Depending on the plant, there may be enough active unburned carbon and contact with the mercury in the flue gas to convert all of the mercury to the oxidized form, or they may not be enough to oxidize any mercury, or there may be any other proportion of oxidized and elemental mercury at the stack. Unlike the oxidized forms, the metal in the zero valence state is difficult to remove due its high volatility and low water solubility.

Some of the existing mercury removal technologies involve scrubbing solution as in a wet flue-gas desulfurization system, filtration and other inertial methods, electrostatic precipitation, and activated-carbon based sorbents and a few other types of sorbents.

Sorbent injection is one of the most promising technologies for application to the utility industry as virtually all coal-fired boilers are equipped with either an electrostatic precipitator (ESP) or a bag house. Accordingly, there is a need for novel oxidative sorbent compositions and methods to substantially reduce mercury emissions into the environment. There has been a need for novel oxidative sorbent compositions and methods to efficiently, economically, and substantially reduce mercury from flue gas.

### SUMMARY

A first embodiment is a composition for the removal of mercury from a fluid, the composition that includes a polysulfide selected from the group consisting of a calcium sulfide and a bromosulfide; the polysulfide supported by or carried on a surface of a silicate particulate.

Another embodiment is a process for manufacturing the bromosulfide or calcium-sulfide mercury-removal composition.

Yet another embodiment is a process of capturing mercury from a fluid, the process can include admixing a bromosulfide or calcium-sulfide mercury-removal composition and a fluid that includes mercury; wherein the bromosulfide mercury removal composition includes a bromosulfide supported by or carried on a surface of a silicate particulate; wherein the calcium-sulfide mercury-removal composition includes a calcium sulfide supported by or carried on a surface of a silicate particulate.

### DETAILED DESCRIPTION

The mercury sorbent material described herein is a supported polysulfide composition that includes a polysulfide component and a supporting silicate particulate. The methods disclosed herein include the process of manufacturing the supported polysulfide composition and a process of employing the supported polysulfide composition to collect and remove mercury from a fluid (e.g., flue gases).

In accordance with the methods and materials disclosed herein, the mercury sorbent material can be a composition that includes a polysulfide selected from the group consisting of a calcium sulfide and a bromosulfide where the polysulfide is supported by or carried on a surface of a silicate particulate.

In accordance with another aspect of the herein described methods and materials, the supported polysulfide composition includes a particulate material capable of carrying the polysulfide. In the preferred embodiment, the particulate material is a silicate particulate. Other particulate materials are possible, for example, carbon based particulates, transition-metal based particulates, and aluminate particulates. Notably, silicon and aluminum occur in many applicable particulate materials, and herein the term silicate includes both silicate and aluminosilicate materials. The silicate particulate can be a mineral-based silicate (e.g., a clay). The mineral-based silicates can be selected from the group consisting of kaolinite, bentonite, montmorillonite, hectorite, beidellite, saponite, nontronite, volkonskoite, sauconite, stevensite, fluorohectorite, laponite, rectonite, vermiculite, illite, a micaceous mineral, makatite, kanemite, octasilicate (illierite), magadiite, kenyaite, attapulgite, palygorskite, sepoilite, and a mixture thereof. In another preferable example, the silicate particulate has exchangeable cations.

In one example, the polysulfide is a bromosulfide. That is, the polysulfide is the reaction product of elemental bromine and elemental sulfur. Without being bound by theory, it is believed that the reaction of elemental bromine and elemental sulfur provides a bromosulfide composition that has an approximate formula of Br₂Sₓ. One example of the bromosulfide is sulfur dibromide (dibromodisulfane): Br₂S₂. Other examples can include, Br₂S₃, Br₂S₄ and higher polysulfides. In still another example, the bromosulfide is an admixture of Br₂S₂ and elemental sulfur. In other examples, the bromosulfide is an admixture of material that has the formula Br₂Sₓ and elemental sulfur. Preferably, the mercury sorbent material and thereby the bromosulfide does not include elemental bromine, even more preferably, the mercury sorbent material and thereby the bromosulfide includes a molar excess of sulfur to bromine.

In another example, the polysulfide is a calcium sulfide. For example, the calcium sulfide can be the reaction product of Ca(OH)₂ and elemental sulfur. The calcium sulfide can have an approximate formula of CaSx wherein x can be 2, 3, 4, 5, 6, 7, 8, 9 or more. In one aspect the calcium sulfide can include a thiolate (e.g., SH, S₂H, S₃H, S₄H, or longer thiolates). Importantly, the calcium sulfide includes S-S bonding. In one example, the mercury sorbent material and thereby the calcium sulfide includes a molar excess of sulfur to calcium.

The composition can be further described by the amount of polysulfide carried by the support. In one example, the majority of the composition (by weight) is the support. For example, the composition can includes less than 50 wt. %, 40 wt. %, 30 wt. % , 25 wt. %, 20 wt. %, 15 wt. %, or 10 wt. % polysulfide (to the combination of polysulfide and silicate particulate). The measure of composition by weight excludes water or other dispersant. That is, a mercury sorbent material can be dispersed in water but the dispersion into water does not affect the relative weight percentages.

The herein described supported polysulfide can be prepared by the combination of bromine or calcium components, sulfur, and the silicate support. The bromosulfide mercury removal composition can be prepared by a process of manufacturing that includes admixing elemental bromine and elemental sulfur to produce a bromosulfide; and then admixing the bromosulfide with a silicate support. In another example, the process includes admixing elemental bromine with a silicate support; and then admixing elemental sulfur with the bromine-silicate admixture. In still another example, the process includes admixing elemental sulfur with a silicate support; and then adding elemental bromine to the sulfur-silicate admixture. The amounts of Br₂ admixed with elemental sulfur correspond to the molar ratio of a product that has an approximate formula of, for example, Br₂S₃ or Br₂S₄.

The calcium-sulfide mercury-removal composition can be prepared by a process of manufacturing that includes admixing Ca(OH)₂ with a silicate support; and then admixing elemental sulfur with the Ca(OH)₂-silicate admixture. In another example, the process can include admixing Ca(OH)₂ and elemental sulfur to produce a calcium sulfide; and then admixing the calcium sulfide with a silicate support. The amounts of Ca(OH)₂ admixed with elemental sulfur correspond to the molar ratio of a product that has an approximate formula of CaSx wherein x can be 2, 3, 4, 5, 6, 7, 8, 9 or more.

Yet another embodiment of the methods and materials disclosed herein is a process of capturing mercury from a fluid. In one example, the process of capturing mercury from a fluid includes admixing the above described bromosulfide or calcium-sulfide mercury-removal composition and a fluid that includes mercury. Preferably, the fluid is a flue gas produced by the combustion of coal. More preferably, the fluid includes oxidized mercury, for example, Hg(I) and/or Hg(II). Even more preferably, the process additionally includes reacting the mercury removal composition with the mercury in the fluid, forming a mercury sulfide either separate from or supported on the silicate particulate; and then separating the mercury sulfide from the fluid.

The foregoing description is given for clearness of understanding only, and no unnecessary limitations should be understood therefrom, as modifications within the scope of the invention may be apparent to those having ordinary skill in the art.

1. A composition for the removal of mercury from a fluid, the composition comprising:
a polysulfide that is a calcium sulfide;
supported by or carried on a surface of a silicate particulate;
wherein the calcium sulfide is the reaction product of Ca(OH)₂ and elemental sulfur.

2. The composition of claim 1, wherein the composition includes a weight percentage of the silicate particulate and a weight percentage of the polysulfide; and wherein the composition includes less than 25 wt. %, of the polysulfide.

3. (canceled)

4. A method for manufacturing a calcium-sulfide mercury-removal composition comprising a two-step process selected from the group consisting of:
admixing Ca(OH)₂ with a silicate support and then admixing elemental sulfur with the Ca(OH)₂-silicate admixture; and
admixing Ca(OH)₂ and elemental sulfur to produce a calcium sulfide and then admixing the calcium sulfide with a silicate support.

5. A process of capturing mercury from a fluid, the process comprising:
admixing a calcium-sulfide mercury-removal composition and a fluid that includes mercury;
wherein the calcium-sulfide mercury-removal composition includes a calcium sulfide supported by or carried on a surface of a silicate particulate; and
preferably, wherein the fluid is a flue gas produced by the combustion of coal.

6. The composition of claim 1, wherein the silicate particulate is selected from the group consisting of kaolinite, bentonite, montmorillonite, hectorite, beidellite, saponite, nontronite, volkonskoite, sauconite, stevensite, fluorohectorite, laponite, rectonite, vermiculite, illite, a micaceous mineral, makatite, kanemite, octasilicate (illierite), magadiite, kenyaite, attapulgite, palygorskite, sepoilite, and a mixture thereof.

7. The composition of claim 1, wherein the composition consists of the polysulfide supported or carried by the silicate particulate.

8. The method of claim 4, wherein the silicate support is selected from the group consisting of kaolinite, bentonite, montmorillonite, hectorite, beidellite, saponite, nontronite, volkonskoite, sauconite, stevensite, fluorohectorite, laponite, rectonite, vermiculite, illite, a micaceous mineral, makatite, kanemite, octasilicate (illierite), magadiite, kenyaite, attapulgite, palygorskite, sepoilite, and a mixture thereof.

9. The method of claim 8, wherein the method comprises admixing Ca(OH)₂ with the silicate support, and then admixing elemental sulfur with the Ca(OH)₂-silicate admixture.
